(19) United States
(12) Patent Application Publication
(10) Pub. No.: US 2009/0181723 A1
(43) Pub. Date: Jul. 16, 2009

(54) APPARATUS AND METHOD FOR PROVIDING AUDIO SIGNAL AND/OR VISUAL INDICATIONS OF CELL PHONE SIGNAL QUALITY OR SIGNAL STRENGTH

(76) Inventor: Lawrence J. Koncelik, JR., East Hampton, NY (US)

Correspondence Address: Mr. Walter J. Tencza Jr;Suite 210, 100 Menlo Park, Edison, NJ, 08837, US

(21) Appl. No.: 11/972,951

(22) Filed: Jan. 11, 2008

(51) Int. Cl. H04M 1/00

(52) U.S. Cl. 455/566; 455/550.1

(57) ABSTRACT

A cellular telephone is provided including a receiver, a processor, a speaker, and an actuator. The receiver may receive a received signal having a level of quality and may supply the received signal to the processor. The actuator when activated may send an actuator signal to the processor. The processor may determine a first sound that will be emitted from the speaker based on the actuator signal and the level of quality of the received signal. The processor after determining the first sound, may send a speaker signal to the speaker which causes the speaker to emit the first sound.

### FIELD OF THE INVENTION

This invention relates to improved methods and apparatus for the communication of cell phone signal quality and/or strength.

### BACKGROUND OF THE INVENTION

Wireless communication devices such as satellite and terrestrial cellular radio telephones, also called cell phones, often include a circuit for determining the strength of a communication signal received via the airwaves by the cell phone. See for example U.S. Pat. Nos. 5,239,684 and 5,959,139. The strength of the communication signal received by the cell phone is usually displayed visually on a display or monitor of the cell phone or, in some cases, by audio sounds. The latter is a more common feature for cell phones made for blind people. For example, one company, Osway (trademarked) has a screenless cell phone called “22 C” that communicates signal strength by sound.

However, as pointed out in U.S. Pat. No. 6,850,736, to McCune, measuring and displaying the received signal strength (RSSI) is really a poor indicator of actual quality of communication available from a received radio signal because reduced signal strength is likely to have no impact on actual quality of the communication. I.e. a weak signal does not mean poor quality of communication because of interference factors. McCune's patent is for an apparatus and method for determining and visually indicating received signal quality that more accurately reflects the received signal quality of the communication available from a received signal. While McCune's apparatus discloses a visual display of the received signal's quality, it does not disclose any means for audio communication of this information to the cell phone user.

The prior art does not disclose a cell phone with a dedicated button that can display or indicate, by sound, either or both the signal strength and/or signal quality received by a cell phone.

### SUMMARY OF THE INVENTION

In one embodiment of the present invention, cellular telephone is provided including a receiver, a processor, a speaker, and an actuator. The receiver may receive a received signal having a level of quality and may supply the received signal to the processor. The actuator when activated or actuated may send an actuator signal to the processor. The processor may determine a first parameter indicative of a first sound that will be emitted from the speaker based on the actuator signal and the level of quality of the received signal. The processor after determining the first parameter, may send a speaker signal, including the first parameter, to the speaker which causes the speaker to emit the first sound.

The actuator may be a button which is activated or actuated by pushing the button. The cellular telephone may further include a memory. An indicator or parameter of the first sound may be recorded in the memory and may be used to form the speaker signal. The first sound may be a human voice or a non-verbal sound. The first sound may include one or more further sounds, with a large number of further sounds indicating that the received signal has a high level of quality and a small number of further sounds indicating that the received signal has a lower level of quality. One further sound may indicate that there is no appreciable received signal, two further sounds may indicate that the received signal has a level of quality which is of poor quality, three further sounds may indicate that the received signal has a level of quality which is of fair quality; and four further sounds indicate that the received signal has a level of quality which is of good quality. Each of the further sounds may be beeps.

The cellular telephone may further include a display. In at least one embodiment, the user can cause the processor to display on the display a visual indicator of a signal strength of the received signal by pressing an actuator, such as an actuator button. The user can cause the processor to display on the display a visual indicator of the level of quality of the received signal by pressing an actuator, such as an actuator button. The user can cause the processor to display on the display a visual indicator of the level of quality of the received signal by pressing the actuator button. The user can cause the processor to display a visual indication of the signal strength while simultaneously displaying a visual indication of the signal quality.

The user can cause the processor to automatically display a visual indication of the signal strength while simultaneously displaying a visual indication of the signal quality by turning on the cell phone.

The actuator can be activated to toggle between causing the processor to cause the display to display a visual indicator of a signal strength of the received signal and causing the processor to cause the display to display a visual indicator of the level of quality of the received signal. The processor may be programmed to display a visual indicator of a signal strength of the received signal when the cellular telephone is turned on.

In one embodiment, the cellular telephone may include a device for turning the cellular telephone off and on. In response to activation of the device for turning the cellular telephone on, an on signal may be supplied to the processor. The processor may response by causing the display to simultaneously display first and second visual indications corresponding to level of quality and signal strength of the received signal.

In at least one embodiment, a method is provided including receiving a received signal having a level of quality at a receiver of a cellular telephone, supplying the received signal to a processor of the cellular telephone, sending an actuator signal to the processor when an actuator is actuated, using the processor to determine a first sound that will be emitted from a speaker based on the actuator signal and the level of quality of the received signal, and after determining the first sound, sending a speaker signal to the speaker which causes the speaker to emit the first sound.

### BRIEF DESCRIPTION OF THE DRAWINGS

FIG. 1 shows a simplified diagram of an apparatus in accordance with an embodiment of the present invention; and

FIG. 2 shows a block diagram of components for use with the apparatus of FIG. 1.

### DETAILED DESCRIPTION OF THE DRAWINGS

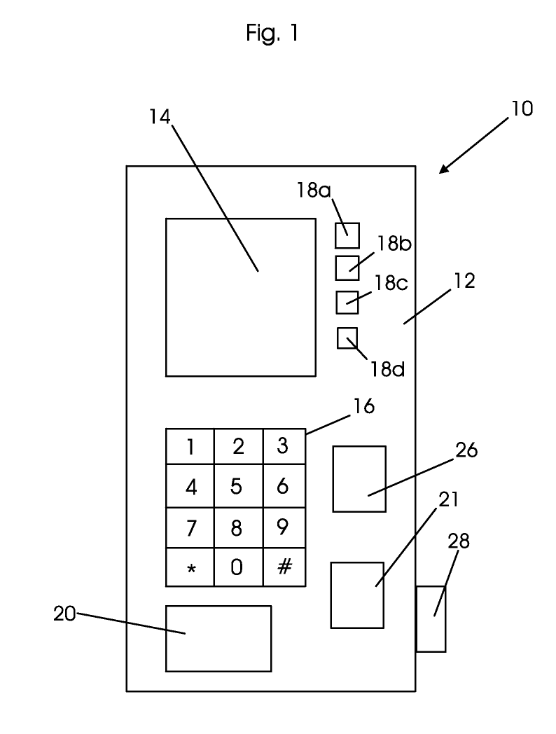

FIG. 1 shows a simplified diagram of an apparatus 10 in accordance with an embodiment of the present invention. The apparatus 10 may be a cellular or cell telephone. The apparatus 10 may include a housing 12, a display or monitor 14, a telephone keypad 16, an audio signal quality or signal strength display toggle actuator, such as actuator 28, a speaker 20, an on/off device 21, a transmitter/receiver 26, as shown in FIG. 1. The apparatus 10 also includes light emitting diodes (LEDs) 18a, 18b, 18c, and 18d.

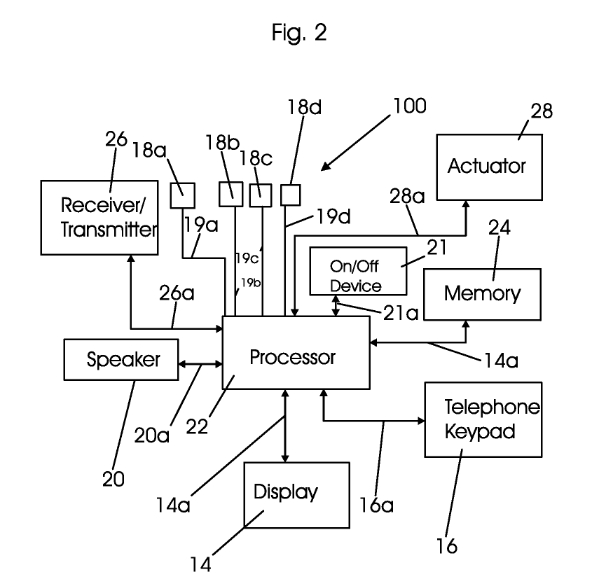

FIG. 2 shows a block diagram 100 of components for use with the apparatus 10. The diagram 100 includes processor 22 and memory 24 which may be located within the housing 12 of the apparatus or cell phone 10. The diagram 100 further includes display 14, telephone keypad 16, an audio signal quality or signal strength display toggle actuator, such as actuator 28, speaker 24, and on/off device 21, for turning the cell phone or apparatus 10 on and off. The processor 22 communicates with the display 14, the telephone keypad 16, the speaker 20, the on/off device 21, the memory 24, the transmitter/receiver 26, and the actuator 28 via communications links 14a, 16a, 20a, 21a, 24a, 26a, and 28a, respectively. The processor 22 communicates with LEDs 18a-d via communications links 19a-d, respectively. The communications links 14a, 16a, 20a, 21a, 24a, 26a, 28a and 18a-d may be any kind of communication link such as a fiber optics, hardwired, software, wireless, or any combination of such communications links.

In operation, an individual would press the actuator 28, which in one embodiment would be a push button switch. This would cause the actuator 28 to send a signal to the processor 22 via communications link 28a. The processor 22 would respond to this signal by sending an audio signal out of the speaker 20 which will indicate the cell phone or apparatus 10 communication quality.

The processor 22 can be programmed to cause a sound to be emitted by the speaker 20. The sound emitted by the speaker 20 could be any sound including a human voice. The sound could also be a non-language or non verbal sound such as a beep or a series of beeps.

The actuator 28 could be a button located anywhere on the apparatus or cell phone 10, such as on the housing 12 of the cell phone 10 as shown in FIG. 1. A user of the cell phone or apparatus 10 could determine from the sound emitted by the speaker 20 (such as, for example, by counting the number of beeps emitted from the speaker 20, to determine the actual quality of a communication available from a received radio signal) the quality of the signal. For example, a single beep may indicate no signal of sufficient quality to communicate, two beeps poor signal quality, three beeps—fair signal quality and four beeps—good signal quality. The processor 22 may be programmed to cause the appropriate number of beeps to be produced based on the signal quality which may be analyzed in accordance with the technique disclosed in U.S. Pat. No. 6,850,736, to McCune which is incorporated herein by reference.

The display 14 may include a signal strength display. In one embodiment, a user of the cell phone 1, can view the signal strength by looking at the visual display 14, and/or the user could, by sound, determine the signal quality by pushing the audio signal quality actuator 18 on the cell phone 1. This is helpful for cell phone users who want to know whether a problem with cell phone reception lies with poor quality of the received signal or a lack of signal strength. The solution to either of these problems might be different—i.e. a poor signal quality usually means better quality signal is only a short distance away from the interference causing the poor quality. However, if the user is in a no signal area, he/she would know that it would be necessary to move to a place, perhaps miles away, to where there was reception.

In another embodiment the user of the cell phone, such as apparatus 1, can view the signal quality by looking at the display 14 and the user can learn, by sound, the signal quality by pushing the actuator 28, such as a signal quality alert button. This would be helpful for cell phone users who are multi tasking while using a cell phone—e.g. driving a car.

In another embodiment, signal quality or signal strength may be displayed on the display 14 by a the actuator 28 shown in FIG. 1. The actuator 28 may allow a user to toggle or switch between either a signal strength display mode or a signal quality display mode on the display 14. A cell phone, such as 1, when turned on may display on the display 14, signal strength, but when the actuator 28 is pushed the display 14 may display signal quality instead of signal strength, and, if the actuator 28 is pushed again it may toggle back to causing the display 14 to display signal strength instead of signal quality.

The actuator 28 can serve different purposes. The actuator 28 can be pushed to activate the display 14 to show signal strength and pushed again, to show signal quality. The processor 22 could also be programmed to cause an audio sound to be emitted from speaker 20 indicating how good the cell phone signal quality is or a different sound to indicate how good the signal strength of the cell phone is, when the actuator 28 is pressed. Alternatively, the processor 22 can be programmed to cause the display 14 to display a visual indicator of signal quality of the cell phone and/or signal strength of the cell phone, when the actuator 28 is pressed and, at the same time, to cause the speaker 20 to emit different sounds to indicate signal quality or strength of the cell phone or apparatus 10. In an embodiment such as the person using the cell phone or apparatus 10 can either look at the display 14 to see signal strength or signal quality and the user could determine the signal quality or signal strength by listening to the sound(s) without having to look at the display 14.

In other words, in one embodiment, the processor 12 can be programmed so that when the one dedicated button, such as actuator 28, is pressed or otherwise actuated, the actuator 28 will send a signal to the processor 12 which will cause the processor 12 to cause any one or all or any combination of many functions described above. These functions may include indicating by sound or visually the received signal quantity or signal strength at the cell phone or apparatus 10. One type of sound would indicate received signal quality, and another type of sound would indicate received signal strength.

The LEDs 18a-d may indicate signal strength or signal quality. In one embodiment, if LED 18a is the only LED of 18a-d which is active or lit, that would indicate that the cell phone 10 is receiving weak signal strength or quality. If two LEDs are active, such as 18a and 18b, it would indicate that dell phone 10 is receiving stronger signal strength or quality. If three LEDs are active, such as 18a, 18b, and 18c it would indicate still stronger signal strength or quality, and if all four LEDs are active, such as 18a-d it would indicate that the cell phone 10 is receiving the strongest signal strength or quality.

In at least one embodiment, the user can cause the processor 12 to display a visual indication of the signal strength while simultaneously displaying a visual indication of the signal quality, on the display 14. For example, the processor 12 may be programmed to respond to the pressing or otherwise activation of the actuator 28 by sending a signal or signals to the display 14 which causes the display 14 to simultaneously display visual indications of received signal strength and quality at the cellular telephone or apparatus 10. The processor 12 may determine first and second parameters which may be indicative of the first and second visual indications which may be substantially displayed on the display 14.

In another embodiment, the user can cause the processor 12 to automatically display a visual indication of the signal strength while simultaneously displaying a visual indication of the signal quality by turning on the cell phone or apparatus 10 by activating on/off device 21, which may be a push button. For example, the processor 12 may be programmed to respond to the turning of the cell phone or apparatus 10, such as by an on/off button or device 21, by sending a signal or signals to the display 14 which causes the display 14 to simultaneously display visual indications of received signal strength and quality at the cellular telephone or apparatus 10. The processor 12 may determine first and second parameters which may be indicative of the first and second visual indications which may be substantially displayed on the display 14. The first and second parameters or indicators may be stored in memory 24.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A cellular telephone comprising:
a receiver;
a processor;
a speaker; and a
an actuator;
wherein the receiver receives a received signal having a level of quality and supplies the received signal to the processor; and
wherein the actuator when activated sends an actuator signal to the processor;
wherein the processor determines a first parameter indicative of a first sound that will be emitted from the speaker based on the actuator signal and the level of quality of the received signal;
and wherein the processor after determining the first parameter, sends a speaker signal including the first parameter to the speaker which causes the speaker to emit the first sound.

2. The cellular telephone of claim 1 wherein
the actuator is a button which is activated by pushing the button.

3. The cellular telephone of claim 1 further comprising
a memory;
and wherein an indicator of the first sound is recorded in the memory and used to form the speaker signal.

4. The cellular telephone of claim 3 wherein
the first sound is a human voice.

5. The cellular telephone of claim 3 wherein
the first sound is a non-verbal sound.

6. The cellular telephone of claim 1 wherein
the first sound includes one or more further sounds, with a large number of further sounds indicating that the received signal has a high level of quality and a small number of further sounds indicating that the received signal has a lower level of quality.

7. The cellular telephone of claim 6 wherein
one further sound indicates that there is no appreciable received signal;
two further sounds indicate that the received signal has a level of quality which is of poor quality;
three further sounds indicate that the received signal has a level of quality which is of fair quality; and
four further sounds indicate that the received signal has a level of quality which is of good quality.

8. The cellular telephone of claim 7 wherein
each of the further sounds are beeps.

9. The cellular telephone of claim 1 further comprising
a display;
and wherein the user can cause the processor to display on the display a visual indicator of a signal strength of the received signal by activating the actuator.

10. The cellular telephone of claim 1 further comprising
a display;
and wherein the user can cause the processor to display on the display a visual indicator of the level of quality of the received signal by activating the actuator.

11. The cellular telephone of claim 10 wherein
the user can cause the processor to display on the display a visual indicator of the level of quality of the received signal by activating the actuator.

12. The cellular telephone of claim 11 wherein
the actuator can be activated to toggle between causing the processor to cause the display to display a visual indicator of a signal strength of the received signal and causing the processor to cause the display to display a visual indicator of the level of quality of the received signal.

13. The cellular telephone of claim 12 wherein
the processor is programmed to display a visual indicator of a signal strength of the received signal when the cellular telephone is turned on.

14. A method comprising:
receiving a received signal having a level of quality at a receiver of a cellular telephone;
supplying the received signal to a processor of the cellular telephone;
sending an actuator signal to the processor when an actuator is actuated;
using the processor to determine a first parameter indicative of a first sound that will be emitted from a speaker based on the actuator signal and the level of quality of the received signal;
after determining the first parameter, sending a speaker signal including the first parameter, to the speaker which causes the speaker to emit the first sound.

15. The method of claim 14 wherein
the actuator is a button which is activated by pushing the button.

16. The method of claim 14 further comprising
retrieving an indicator of the first sound from memory and wherein the speaker signal is based on the indicator of the first sound.

17. The method of claim 16 wherein
the first sound is a human voice.

18. The method of claim 16 wherein
the first sound is a non-verbal sound.

19. The method of claim 14 wherein
the first sound includes one or more further sounds, with a large number of further sounds indicating that the received signal has a high level of quality and a small number of further sounds indicating that the received signal has a lower level of quality.

20. The method of claim 19 wherein
one further sound indicates that there is no appreciable received signal;
two further sounds indicate that the received signal has a level of quality which is of poor quality;
three further sounds indicate that the received signal has a level of quality which is of fair quality; and
four further sounds indicate that the received signal has a level of quality which is of good quality.

21. The method of claim 20 wherein
each of the further sounds are beeps.

22. The method of claim 14 further comprising
causing the processor to display on a display a visual indicator of a signal strength of the received signal by actuating the actuator.

23. The method of claim 14 further comprising
causing the processor to display on the display a visual indicator of the level of quality of the received signal by activating the actuator.

24. The method of claim 22 wherein
causing the processor to display on the display a visual indicator of the level of quality of the received signal by activating the actuator.

25. The method of claim 24 wherein
the actuator can be activated to toggle between causing the processor to cause the display to display a visual indicator of a signal strength of the received signal and causing the processor to cause the display to display a visual indicator of the level of quality of the received signal.

26. The method of claim 25 wherein
the processor is programmed to display a visual indicator of a signal strength of the received signal when the cellular telephone is turned on.

27. An cellular telephone comprising
a receiver;
a processor;
a display; and a
an actuator;
wherein the receiver receives a received signal having a level of quality and a signal strength and supplies the received signal to the processor; and
wherein the actuator when activated sends an actuator signal to the processor;
wherein the processor determines a first parameter indicative of a first visual indication that will be displayed on the display based on the actuator signal and the level of quality of the received signal;
wherein the processor determines a second parameter indicative of a second visual indication that will be displayed on the display based on the actuator signal and the signal strength of the received signal;
and wherein the processor after determining the first parameter and the second parameter, sends one or more signals to the display which causes the display to substantially simultaneously display the first visual indication and the second visual indication.

28. An cellular telephone comprising
a receiver;
a processor;
a display; and a
a device for turning the cellular telephone on;
wherein the receiver receives a received signal having a level of quality and a signal strength and supplies the received signal to the processor; and
wherein the device for turning the cellular telephone on, when activated, sends an on signal to the processor;
wherein the processor determines a first parameter indicative of a first visual indication that will be displayed on the display based on the on signal and the level of quality of the received signal;
wherein the processor determines a second parameter indicative of a second visual indication that will be displayed on the display based on the on signal and the signal strength of the received signal;
and wherein the processor after determining the first parameter and the second parameter, sends one or more signals to the display which causes the display to substantially simultaneously display the first visual indication and the second visual indication.
